(19) United States
(12) Patent Application Publication
(10) Pub. No.: US 2011/0261669 A1
(43) Pub. Date: Oct. 27, 2011

(54) OPTIC DISC COPYING DEVICE WITH VOICE OUTPUT

(75) Inventors: Mao Huai Weng, Taipei Hsien (TW); Hsia Pin Liao, Taipei Hsien (TW); Wen Chu Chuang, Taipei Hsien (TW)

(73) Assignee: ACARD Technology Corp., Taipei Hsien (TW)

(21) Appl. No.: 12/764,393

(22) Filed: Apr. 21, 2010

(51) Int. Cl. G11B 3/64

(52) U.S. Cl. 369/84; G9B/3.097

(57) ABSTRACT

Provided is an optic disc copying device with voice output, including an optic disc drive, at least one disc burner, and a copying controller. The copying controller includes a voice output circuit module for retrieving, from an optic disc loaded in either the optic disc drive or the disc burner, voice data, which after being processed and converted, are output to realize a voice output function. As such, after a copying operation, a newly copied optic disc can be immediately displayed for aural inspection of the music or sounds/voices contained in the disc and the device also shows a function of music displaying.

### BACKGROUND OF THE INVENTION

1. Field of the Invention

The present invention is related to an optic disc copying device with voice output, and more particular to an optic disc copying device that serves as an independent system.

2. Description of Related Art

An optic disc burner, which is either built in a computer or a separate device externally connected to a computer, is set in connection with the computer system, whereby after a copying operation of an optic disc, the audio or voice data contained in the optic disc can be displayed through a sound displaying device combined in the computer system. Thus, both the source optic disc and a destination optic disc to which copying of audio or voice data is made allow for broadcasting of audio sounds through the computer system, so that a user can immediately enjoy listening to music or aurally inspects the contents of the optic disc that was just made.

A stand-alone one-to-one or one-to-multiple optic disc copying device that is currently available in the market can operate independently, without connection with a computer system, to carry out fast backing up of data contained in an optic disc. However, such a stand-alone optic disc copying device is provided with no voice output function so that after copying of video/audio data contained in a source optic disc is completed, there is no way for a user to immediately aurally inspect the contents of the optic disc that was just made. A separate computer system or sound displaying device must be adopted to display the voice contents of the optic disc. This makes the operation and use of the known copying device inconvenient.

The present invention aims to overcome the drawback of an existing stand-alone optic disc copying device that is of no voice output so as to realize integrity of interfaces which allows for fast speed of data transmission and convenience of use.

### SUMMARY OF THE INVENTION

A primary objective of the present invention is to provide an optic disc copying device with voice output, which comprises a copying controller that realizes a voice output function through being in combination with a voice output circuit module, whereby the contents of a newly copied optic disc can be immediately aurally inspected after the copying is done so as to provide convenience of use and to allow the optic disc copying to alternatively serve as a device for displaying music thereby providing a user with more complete functions.

In order to achieve the foregoing objective, the present invention provides an optic disc copying device with voice output, which comprises an optic disc drive, which receives a source optic disc to be loaded therein; at least one disc burner, which receives a blank destination optic disc to be loaded therein for writing; and a copying controller, which is connected to the optic disc drive and the disc burner for controlling an optic disc copying operation, the copying controller comprising a control unit, a voice output circuit module connected to the control unit, and a voice output unit.

The present invention further comprises an operation panel unit connected to control unit, whereby through selection of voice displaying functions through the operation panel unit, the control unit controls the voice output circuit module to retrieve voice data from the optic disc loaded in either the optic disc drive or disc burner to allow the voice data, after being processed and converted, to be output through the voice output unit.

The optic disc drive, the disc burner, and the copying controller can be of SATA (Serial Advanced Technology Attachment) interface, SAS (Serial Attached SCSI) interface, or USB (Universal Serial Bus) interface, which allows for fast speed of data transmission.

### BRIEF DESCRIPTION OF THE DRAWINGS

The present invention can be fully understood from the following detailed description and preferred embodiment with reference to the accompanying drawings, in which:

FIG. 1 schematically shows system architecture of an optic disc copying device with voice output according to the present invention; and

FIG. 2 is a block diagram of the optic disc copying device according to the present invention.

### DETAILED DESCRIPTION OF THE PREFERRED EMBODIMENTS

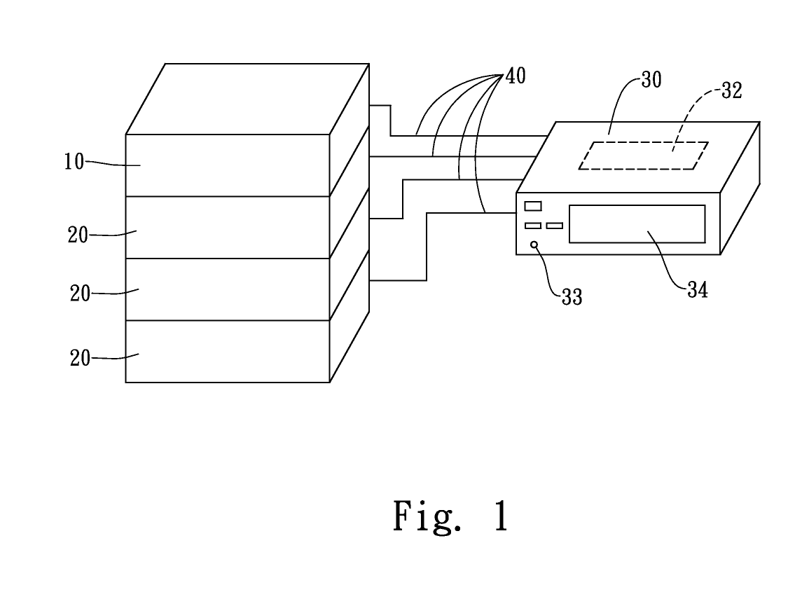

With reference to the drawings and in particular to FIG. 1, which schematically shows system architecture of an optic disc copying device with voice output according to the present invention, the optic disc copying device of the present invention comprises an optic disc drive 10, a plurality of disc burners 20, and a copying controller 30. The optic disc drive 10 functions to receive a source optic disc to be loaded therein for copying. The disc burners 20 function to selectively and respectively receive blank destination optic discs therein for data writing. The copying controller 30 is connected to both the optic disc drive 10 and the disc burners 20 for controlling optic disc copying operation by which data contained in the source optic disc are copied and written to one or each of the blank destination optic discs. The optic disc drive 10, the disc burners 20, and the copying controller 30 are selectively of SATA interface, SAS interface, or USB interface, whereby the optic disc drive 10 and the disc burners 20 are each connected through a transmission cable 40 of SATA, SAS, or USB interface to the copying controller 30.

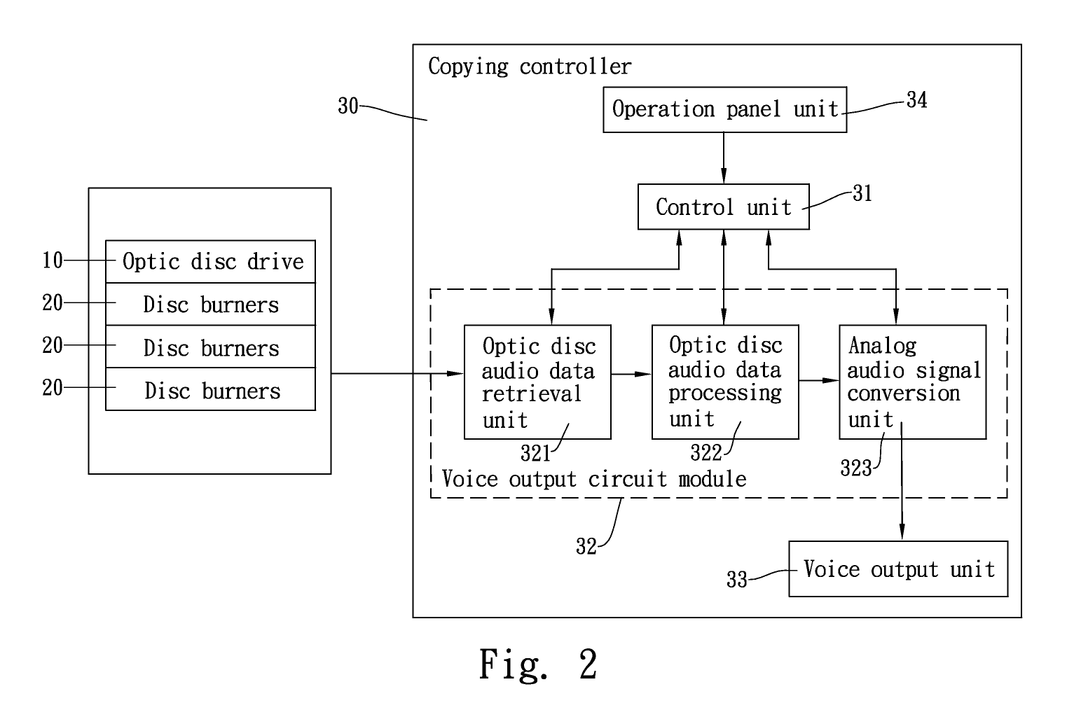

Also referring to FIG. 2, the copying controller 30 comprises a control unit 31, a voice output circuit module 32 connected to the control unit 31, and a voice output unit 33 connected to the voice output circuit module 32. The voice output circuit module 32 comprises an optic disc audio data retrieval unit 321 connected to the optic disc drive 10 and the disc burners 20, an optic disc audio data processing unit 322 connected to the optic disc audio data retrieval unit 321, and an analog audio signal conversion unit 323 connected to the optic disc audio data processing unit 322. The optic disc audio data retrieval unit 321 is connected to the optic disc drive 10 and the disc burners 20 to retrieve voice data that are contained in the source optic disc or that are written into one or each of the blank destination optic discs and the retrieved voice data are processed by the optic disc audio data processing unit 322 and then converted into an analog signal by the analog audio signal conversion unit 323 and finally output as sound through the voice output unit 33. The voice output unit 33 may comprise a voice output socket.

The control unit 31 is also connected to an operation panel unit 34, which comprises keys or pushbuttons and a display screen. Various sound output functions, such as rhythm selection, displaying, volume control, pause, stop, and the likes can be carried out through the operation panel unit 34.

With the above described arrangement, a user may operate the operation panel unit 34 to selectively display an optic disc loaded in either the optic disc drive 10 or one of the disc burners 20 and the control unit 31 controls the optic disc audio data retrieval unit 321 to retrieve voice data from the optic disc, whereby the retrieved voice data, after being processed by the processing unit 322, are converted by the analog audio signal conversion unit 323 into an analog signal to be displayed through the voice output unit 33.

Thus, the optic disc copying device according to the present invention comprises a voice output circuit module, which allows for immediate aural inspection of a newly written optic disc after the copying operation and also provides such a function to allow a user to enjoy listening music or other types of sounds/voices. As such, convenience of use and integrity of function are both realized.

What is claimed is:

1. An optic disc copying device with voice output, comprising:
an optic disc drive, which is adapted to receive a source optic disc to be loaded therein;
at least one disc burner, which is adapted to receive a blank destination optic disc to be loaded therein for writing; and
a copying controller, which is connected to the optic disc drive and the disc burner for controlling an optic disc copying operation, the copying controller comprising a control unit, a voice output circuit module connected to the control unit, and a voice output unit connected to the voice output circuit module.

2. The optic disc copying device with voice output according to claim 1, wherein the voice output circuit module comprises an optic disc audio data retrieval unit, an optic disc audio data processing unit connected to the optic disc audio data retrieval unit, and an analog audio signal conversion unit connected to the optic disc audio data processing unit, the optic disc audio data retrieval unit being in connection with the optic disc drive and the disc burner, the analog audio signal conversion unit being in connection with the voice output unit.

3. The optic disc copying device with voice output according to claim 1, wherein the voice output unit comprises a voice output socket.

4. The optic disc copying device with voice output according to claim 1, wherein the optic disc drive, the disc burner, and the copying controller are of SATA interface.

5. The optic disc copying device with voice output according to claim 1, wherein the optic disc drive, the disc burner, and the copying controller are of SAS interface.

6. The optic disc copying device with voice output according to claim 1, wherein the optic disc drive, the disc burner, and the copying controller are of USB interface.

7. The optic disc copying device with voice output according to claim 1, wherein the control unit is connected to an operation panel unit, which comprises pushbuttons and a display screen.
